(19) United States
(12) Patent Application Publication
(10) Pub. No.: US 2023/0079412 A1
(43) Pub. Date: Mar. 16, 2023

(54) DEVICE FOR ENERGY RECOVERY IN BICYCLES WITH A MID-MOUNTED MOTOR DRIVE UNIT AND METHOD FOR OPERATING THE SAME

(71) Applicant: Gerd SCHEYING, Stuttgart (DE)

(72) Inventor: Gerd SCHEYING, Stuttgart (DE)

(21) Appl. No.: 17/796,113

(22) PCT Filed: Jan. 28, 2021
(86) PCT No.: PCT/DE2021/200008

§ 371 Date: Jul. 28, 2022

(30) Foreign Application Priority Data
Jan. 31, 2020 (DE) 10 2020 201 212.1

(51) Int. Cl. B62M 6/45; B62J 45/00; B62M 17/00; B62M 19/00; B62M 6/55; B62M 6/80; B62M 9/00

(52) U.S. Cl. CPC B62M 6/45; B62J 45/00; B62M 17/00; B62M 19/00; B62M 6/55; B62M 6/80; B62M 9/00; B60L 2200/12; B60Y 2200/13

(57) ABSTRACT

The invention relates to a device for energy recovery in bicycles with a mid-mounted motor drive unit and at least one rear wheel, comprising
a first component that is connected to an element of the rear wheel hub or the rear wheel, such that a rotation of the rear wheel is transmitted to the first component, regardless of the direction of rotation,
an energy-transmission device interacting with the first component,
a recuperation element that interacts with the energy-transmission device, and
a generator that interacts with the recuperation element to recover the rotational energy of the rotational movement of the rear wheel.

The invention relates to a device for energy recovery in bicycles with a mid-mounted motor drive unit.

The invention further relates to a method for operating a device for energy recovery in bicycles with a mid-mounted motor drive unit.

The invention further relates to a bicycle.

Although applicable to any kind of bicycle, the present invention will be described in the context of bicycles in the form of a two-wheeler.

Bicycles often have a drive system to support the human driver, for example when driving uphill. In addition to a rear-wheel drive, located at the hub of the rear wheel, drive units are located at the bottom bracket spindle, between the pedals for the human driver, therefore arranged mainly between the front and rear wheels. In known mid-mounted motor drive units for bicycles or pedelecs, the crankshaft for the foot pedals for the human driver is equipped with known freewheel mechanisms while being connected to the rear wheel hub via a chain drive, commonly comprising of a chain and gearwheels. The freewheeling mechanism is configured in a known manner, such that the pedals of the pedal unit can stand still in operation while sliding, and the spindle in the bottom bracket of the pedal unit does not rotate during sliding operation of the bicycle. The known bicycle-usual free-wheeling mechanisms of bicycle rear wheel hubs lead to the fact that the bicycle chain does not have to move in sliding operation, so the chain, bottom bracket spindle and pedals stand still when driving downhill.

The disadvantage here is that during sliding operation of the bicycle, no energy is transferred between the rotating rear wheel and the mid-mounted motor drive unit at the bottom bracket. Thus, pedelecs with mid-mounted motor drive, for instance, cannot use the energy generated by the rotation of the rear wheel in the mid-mounted motor drive for energy recovery or recuperation.

An objective of the present invention is therefore to provide recuperation for bicycles equipped with a mid-mounted motor drive unit.

A further objective of the present invention is to provide a device for energy recovery, which is cost-effective and easy to manufacture.

In an embodiment, the present invention solves the above-mentioned objectives by a device for energy recovery in bicycles with a mid-mounted motor drive unit and at least one rear wheel, comprising

a first component, which is connected to an element of a rear wheel hub or of the rear wheel such that a rotation of the rear wheel is transmitted to the first component, regardless of the direction of rotation,
an energy-transmission device interacting with the first component,
a recuperation element that interacts with the energy-transmission device, and
a generator, which interacts with the recuperation element to recover the rotational energy of the rotational movement of the rear wheel.

In another embodiment, the present invention solves the above-mentioned objectives by a method for operating a device according to one of the claims 1-15, wherein energy is recovered by means of the device as a function of a drive operation of the bicycle.

In a further embodiment, the present invention solves the above-mentioned objectives by a bicycle provided with a device according to one of the claims 1-15.

One of the advantages achieved is that recuperation can be provided for bicycles/tricycles, in particular two- or three-wheelers equipped with a mid-mounted motor drive unit. A further advantage is that a cost-effective and easy-to-produce device for recovering of energy in bicycles with mid-mounted motor drive unit is provided. A further advantage is that, in particular in the case of a mechanically fixed, non-detachable connection, in sense of power transmission between at least one impeller, in particular the rear wheel of the bicycle and a drive unit with generator, a permanent and constant transmission of the direction of rotation and rotational speed of the impeller is provided, which can be used for a very precise speed determination of the bicycle, in order to prevent the intended use of the power drive from manipulation. In this way, compliance with the type approval of the two-wheeled vehicle with a mid-mounted motor drive unit is facilitated or, in other words, manipulation of speed measurement is impeded.

The term “rear wheel hub” refers to a hub at the rear wheel of a bicycle, which is turning around an axle that is attached in the fork ends or dropouts of the rear bicycle wheel. The essential components can in particular be axles, bearings and hub housings as well as optionally additional elements, such as a brake or the freewheel. The spokes of the respective wheel are then attached to the hub housing.

The term “bicycle” shall be understood in the broadest sense and shall include two wheelers or three-wheelers.

Further features, advantages and further embodiments of the invention are described or become apparent in the following.

According to a preferred embodiment, the energy-transmission device comprises at least one mechanical transmission element and/or at least one hydraulic transmission element. The advantage of a mechanical transmission element is that it is easy to manufacture and that it has little susceptibility to repair, whereas a hydraulic element allows a flexible arrangement on the bicycle.

According to a further preferred embodiment, the energy-transmission device comprises a traction mechanism drive, in particular a timing belt, a chain drive and/or a cardan shaft. This provides energy-transmission devices or energy-transmission elements that are simple and cost-effective in a flexible manner. For example, a timing belt has the advantage that it is particularly easy to assemble and can be replaced cost-effectively, whereas, for example, a cardan shaft provides a particularly reliable energy transmission.

According to a further preferred embodiment, the recuperation element comprises a shaft. In this way, a rotational movement of the rear wheel hub can be converted again into a rotational movement, which allows simple energy recovery by means of the generator.

According to a further preferred embodiment, the recuperation element is arranged in the region between the bottom bracket and the rear wheel hub or in vertical direction above the bottom bracket. The advantage of this is that the recuperation element can be easily arranged at height or behind the driver in relation to the driving direction.

According to a further preferred embodiment, the recuperation element is arranged at least partially outside of the mid-mounted motor drive unit housing or completely inside the housing. If the recuperation element is at least partially arranged outside the housing, a particularly simple connection to the energy-transmission element is possible. With a complete arrangement within the housing, it is protected from environmental influences such as humidity and similarities.

According to a further preferred embodiment, an adaptation device is arranged for the energy-transmission device, which is configured to compensate, at least partially, a deterioration of the energy-transmission by the energy-transmission device. The advantage of this is the opportunity of a longer service life of the energy-transmission device, in particular of mechanically flexible elements, in which the adaption device compensates deteriorated mechanical tension. Examples of this are tensioning devices for a timing belt or a chain.

According to a further preferred embodiment, the recuperation element is configured as a part of the generator, in particular in the form of a generator shaft for a surrounding stator of the generator. Thus, a space-efficient arrangement of the recuperation element and generator is made possible.

According to a further preferred embodiment, the recuperation element is configured as a transmission drive shaft having at least one clutch. One of the advantages then achieved is that the motor of the mid-mounted motor drive unit can thus be used as the generator: This allows during sliding operation that rotational energy can be transmitted to the drive unit, more precisely to an electric motor of the drive unit, so that it can be used as a generator. The energy-transmission can be carried out directly or via a transmission. The clutch, in particular, which is electronically controlled, notably by means of an electronic control or a control unit can then establish a connection for transmission of power to the motor, in particular the electric motor. The control system is configured in such a way that fast switching between sliding operation with recuperation and power drive is made possible despite downhill travel.

According to a further preferred embodiment, the energy-transmission device is located above a drive transmission device of the mid-mounted motor drive unit that drives the rear wheel. The advantage of this is easier accessibility in the case of maintenance.

According to a further preferred embodiment, the energy-transmission device is at least partially arranged in a protective housing. This improves reliability during operation of the energy-transmission device.

According to a further preferred embodiment of the method, sensor data, used for detecting the driving operation, is evaluated by a control device and energy is recovered based on the detected driving operation. This automatically and reliably provides a control of recuperation or energy recovery.

According to a further preferred embodiment of the method, energy recovery is carried out continuously variable and/or in steps depending on the driving operation of the bicycle, Thus, a dosed and coordinated energy recovery, depending on the detected driving condition or the driving operation respectively is made possible.

According to a further preferred embodiment of the method, energy recovery can be activated manually. The advantage of this is an increased flexibility, since the driver of the two-wheeler can decide for himself whether and possibly how, the energy recovery should be engaged. For example, one or more manual modes for automatic switching-on can thus be provided in a control unit.

According to a further preferred embodiment, the energy-transmission device and/or the recuperation element and/or the first component on the one hand and the transmission device of the mid-mounted motor drive unit for driving the rear wheel on the other hand are arranged essentially in essentially spatially separated regions on the bicycle, in particular on different sides of the bicycle. One of the advantages of this arrangement is a simpler implementation.

According to a further preferred embodiment, the first component is permanently connected to the rear wheel hub or detachably connected to the rear wheel and/or the rear wheel hub. One of the advantages of this is that, on the one hand, a reliable transmission of the rotation of the rear wheel is carried out, and maintenance of the rear wheel is also possible in a simple manner. The term “detachable (manner) connection” is to be understood in the broadest sense and refers also to screw connections or the like.

According to a further preferred embodiment, the first component engages into the spokes of the rear wheel for rotation. This ensures that the first component can be removed quickly and easily from the rear wheel.

According to a further preferred embodiment, the first component comprises at least one pin, in particular a plurality of pins for engaging with the spokes. One of the advantages achieved is cost-effectiveness and simple implementation.

Other important features and advantages of the invention result from the claims, the drawings and the corresponding description of figures based on the drawings.

It shall be understood that the above mentioned features as well as further, yet to be explained characteristics, can be employed not only in the combinations indicated in each case, but also in other combinations or alone, without leaving the scope of the present invention.

Preferred embodiments and types of embodiment of the present invention are shown in the drawings and are explained in more detail in the following description, whereas the same reference signs refer to identical or similar or functionally identical components or elements.

It is shown, schematically, in

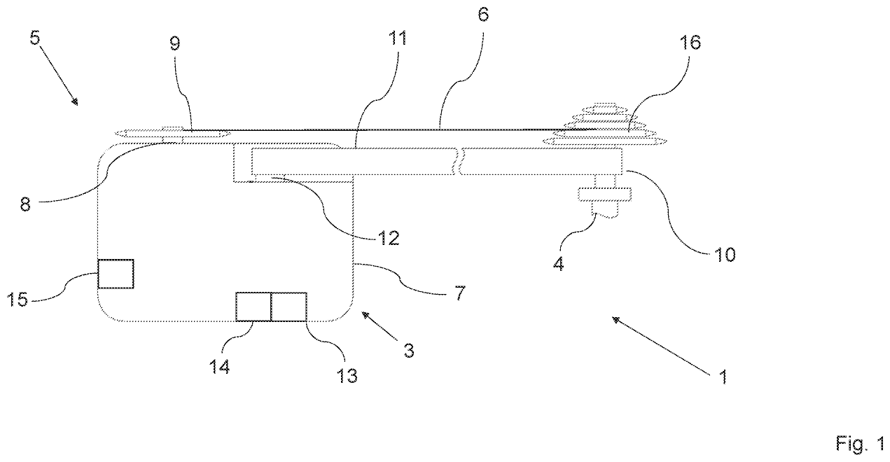

FIG. 1 a device according to an embodiment of the present invention in a top view;

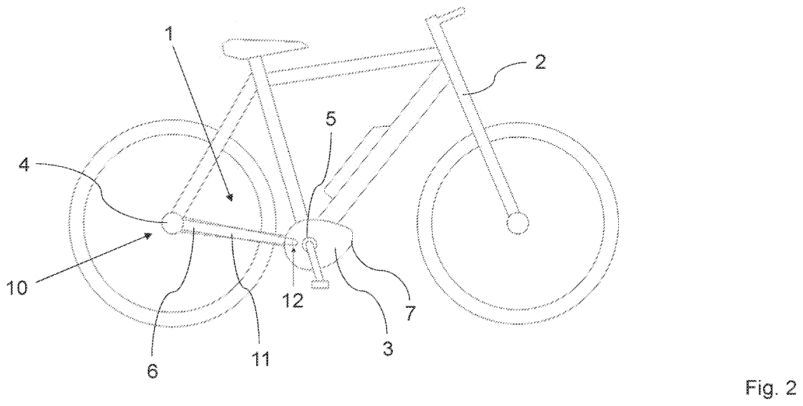

FIG. 2 a device according to an embodiment of the present invention in a side view;

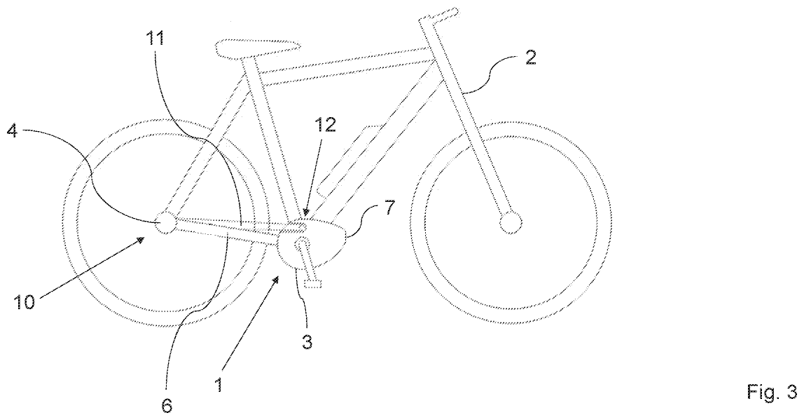

FIG. 3 a device according to an embodiment of the present invention in a side view:

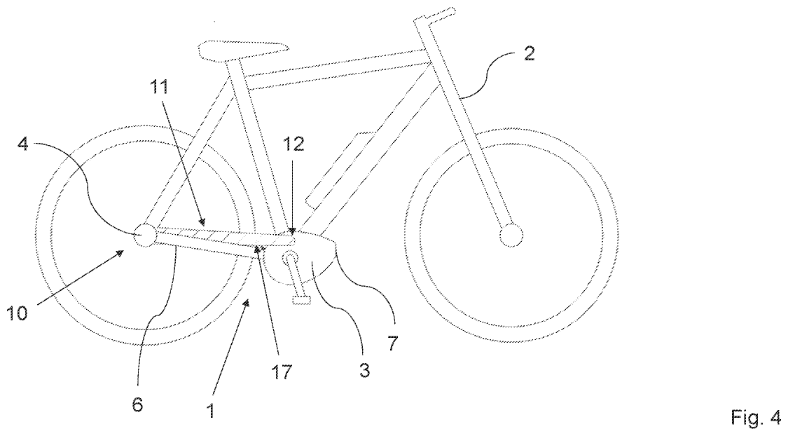

FIG. 4 a device according to an embodiment of the present invention in a side view; and

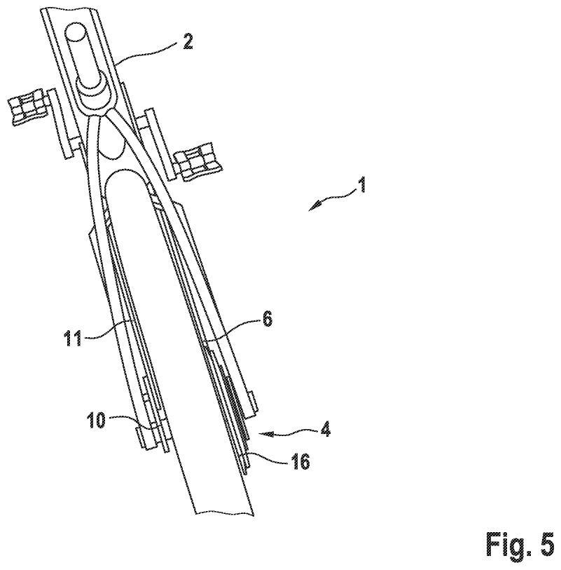

FIG. 5 a device according to an embodiment of the present invention.

FIG. 1 shows a device according to an embodiment of the present invention in a top view.

In detail, FIG. 1 shows a device 1 for recovering energy for a two-wheeler. The two-wheeler has a mid-mounted motor drive unit 3, which has a bottom bracket bearing 5 with bottom bracket spindle 8 with a chainring 9. The chainring 9 is connected via a chain 6 to a sprocket 16, which is mounted on the rear hub 4 of the two-wheeler. By rotation of the chainring 9, the powered drive of the rear wheel of the two-wheeler can take place.

In addition, in FIG. 1 a recess is provided in the upper right part of the housing 7 of the mid-mounted motor drive unit 3, whereas the width of said recess being configured in such way that parallel to the connection between the chainring 9 and the sprocket 16 via the chain 6, a timing belt 11 can be placed. The latter is connected on the one hand to the mid-mounted motor drive unit 3 by the recuperation shaft 12, which projects partially out of the housing 7, and on the other hand to a toothed washer 10, which is fixed to the rear wheel hub 4 of the two-wheeler. The recuperation shaft 12 is hereby arranged “behind” the bottom bracket spindle 8 (thus outlined in FIG. 1 by being arranged on the right-hand side of the bottom bracket spindle) but can also be arranged above it and is mechanically independent of the bottom bracket spindle. The recuperation shaft 12 is hereby mounted in a way that provides the lowest possible resistance for rotational movements of the rear wheel.

In addition, a generator 13 for recuperation and a tensioning device 14 for the timing belt 11 are arranged in the mid-mounted motor drive unit 3. The tensioning device 14, for example in the form of a tension roller, serves to extend the service life of the timing belt 11. Likewise, the mid-mounted motor drive unit 3 comprises a control unit 15 for operating the recuperation. The control unit can also be placed at another position on the two-wheeler.

Altogether, the components of the two-wheeler, in particular the components toothed washer 10, timing belt 11 and recuperation shaft 12 shall have minimum energy consumption, which means that the overall power loss is as low as possible. For example, the contribution of device 1 to the total drive power loss is or is less than 1% in driving operation.

In other words, FIG. 1 shows a device 1 comprising a mechanically fixed connection to the rear wheel hub 4, in particular a small wheel in form of a toothed washer 10, which transmits, in particular by means of a timing belt 11, the rotational movement of the rear wheel, in particular in sliding mode, without freewheel and thus the energy involved in this movement of the rear wheel, to the recuperation shaft 12 of the mid-mounted motor drive unit 3, where the provided energy can be used for recuperation by the generator 13.

In other embodiments, not shown here, the recuperation shaft 12 acts as generator shaft with surrounding stator that is either permanently magnetic and/or has electromagnets, or the recuperation shaft 12 can also be configured as transmission axle with a clutch, configured to transmit the rotational energy in sliding mode to the mid-mounted motor drive unit 3 or its engine/electric motor respectively, which is in this configuration used as the generator for recuperation. With the latter embodiment, a separate generator 13 can then be dispensed with.

FIG. 2 shows a device according to an embodiment of the present invention in a side view.

In detail, FIG. 2 shows a device 1 according to FIG. 1. Here, the recuperation shaft 12 is arranged as in FIG. 1 behind the bottom bracket spindle 8, that is, between bottom bracket spindle 8 and rear wheel hub 4. As shown in FIG. 2, the timing belt 11 runs in parallel to the chain 6 and is arranged in FIG. 2 behind the chain 6—in viewing direction perpendicular to the drawing plane.

FIG. 3 shows a device according to an embodiment of the present invention in a side view.

In detail, FIG. 3 essentially shows a device 1 according to FIG. 1. In contrast to device 1 according to FIG. 1, the recuperation shaft 12 of device 1 is in FIG. 3 arranged vertically above the bottom bracket spindle 8, i.e. on same horizontal “height” as the bottom bracket spindle 8. As shown in FIG. 3, the timing belt 11 runs with an angle to the chain 6 and is arranged above the chain 6.

FIG. 4 shows a device according to an embodiment of the present invention in a side view.

In detail, FIG. 4 essentially shows a device 1 according to FIG. 3. In contrast to the device 1 shown in FIG. 3, in the device 1 according to FIG. 4, the recuperation shaft 12 and the timing belt 11 are protected by a housing 17, at least in the direction out of the drawing plane of FIG. 4.

The recuperation shaft 12 can be guided outwards on both sides of the mid-mounted motor drive unit 3 (thus perpendicular to the drawing plane). The recuperation shaft 12 can be guided outwards in a recess, as shown in FIG. 1, or as shown in FIG. 3 within in the housing 7 of the mid-mounted motor drive unit 3 in order to avoid a collision with the chainring 9 of the bottom bracket spindle. Depending on the positioning of the recuperation shaft 12 in the housing 3, the timing belt 11 runs around or above the chain stay of the frame. When the timing belt 11 runs above the chain stay, as shown in FIG. 3, a cover, for example in the form of a mudguard 17 can be arranged around it in order to protect both the timing belt 11 from dirt, as well as the human operator from the permanently rotating timing belt 11.

Whether the rotational energy available at the recuperation shaft 12 is used for recuperation depends in particular on the driving mode of the two-wheeler 2. The engine control unit 15 can start the recuperation automatically if due to various sensor data (speed of the bottom bracket spindle, angle of inclination of the ground, . . . ), a favorable driving mode (for example downhill) is recognized. In addition, it is conceivable that the recuperation will be switched on automatically when the brakes of the two-wheeler are actuated. As a result, the braking energy is used for recuperation and the brakes themselves are relieved.

The human driver may also be able to switch on the recuperation manually, if said driver intends to charge the energy storage, for example a battery, during the trip, for example in case of a slight downhill run, which cannot yet be considered as favorable for recuperation. By means of a step-by-step engagement, the usability and comfort of the function can be increased.

FIG. 5 shows a device according to an embodiment of the present invention.

In detail, FIG. 5 essentially shows a device 1 according to FIG. 3. In contrast to device 1 according to FIG. 3, at device 1 according to FIG. 5, the toothed washer 10, the timing belt 11 and the recuperation shaft 12 are arranged on the opposite side of sprocket 16, chain 6 and chainring 9 of the rear wheel 18 of the bicycle 2. In other words, recuperation, and drive of the same, are essentially carried out in spatially separated regions on the bicycle 2, in particular on different sides of the bicycle 2. A driving cogwheel respective a toothed washer 10 is mounted in particular on the rear wheel hub 4 and, in an embodiment, engages by one or more elements, for example trunnions, with elements of the rear wheel 18 for example spokes, so that the toothed washer 10 is driven according to the rotation of the rear wheel 18. In this outline, the toothed washer 10 can easily be removed from the rear wheel hub 4 whenever the rear wheel 18 is removed. In this respect, no structural modification of the rear wheel hub 4 may be required, and removal of the timing belt 11 is also not necessary upon removal of the rear wheel 18. Furthermore, a change in rotational speed, in particular an increase of the rotational speed of the recuperation shaft, can easily be provided by means of a corresponding gear ratio between the toothed washer 10 and the recuperation shaft 12. This improves the energy recovery in the drive unit 3 and makes it unnecessary to implement such amended elements within the mid-mounted motor drive 3.

In summary, at least one of the embodiments of the invention has at least one of the following advantages:
Simple assembly or implementation.
Cost-effective production and operation.
Recuperation for two-wheelers with mid-mounted motor drive unit.
Simple maintenance, especially if recuperation and drive are located on different sides and/or in different areas.

Although the present invention has been described on the basis of preferred embodiments, it is not limited to this, but can be modified in a variety of ways.

### LIST OF REFERENCE SIGNS

1 Device for energy recovery
2 Bicycle
3 Mid-mounted motor drive unit
4 Rear wheel hub
5 Bottom bracket
6 Chain
7 Housing
8 Bottom bracket spindle
9 Chainring
10 Toothed washer
11 Timing belts
12 Recuperation shaft
13 Generator
14 Timing belt tensioning device
15 Control unit
16 Sprocket
17 Protective housing
18 Rear wheel

1. A device (1) for energy recovery in bicycles (2) with a mid-mounted motor drive unit (3) and at least one rear wheel (4), comprising:
a first component (10) that is connected to an element of a rear wheel hub (4), or of the rear wheel (18), such that a rotation of the rear wheel (18) is transmitted to the first component (10), regardless of the direction of rotation; an energy-transmission device (11), interacting with the first component (10), a recuperation element (12) that interacts with the energy-transmission device (11), and a generator (13) that interacts with the recuperation element (12) to recover the rotational energy of the rotational movement of the rear wheel.

2. A device according to claim 1, characterized in that the energy-transmission device (11) has at least one mechanical transmission element and/or at least one hydraulic transmission element.

3. A device according to claim 2, characterized in that the energy-transmission device (11) comprises a traction mechanism drive, in particular a timing belt, a chain and/or a cardan shaft.

4. A device according to claim 1, characterized in that the recuperation element (12) comprises a shaft.

5. A device according to claim 1, characterized in that the recuperation element (12) is located in the region between bottom bracket (5) and rear wheel hub (4) or in the vertical direction above the bottom bracket (5).

6. A device according to claim 1, characterized in that the recuperation element (12) is at least partially located outside the housing (7) of the mid-mounted motor drive unit (3) or completely inside the housing (7).

7. A device according to claim 1, characterized in that an adaptation device (14) is arranged for the energy-transmission device (11), which is configured to at least partially compensate a deterioration of the energy transfer of the energy-transmission device (11).

8. A device according to claim 1, characterized in that the recuperation element (12) is configured as part of the generator, in particular in the form of a generator shaft for a surrounding stator of the generator.

9. A device according to claim 1, characterized in that the recuperation element (12) is configured as a transmission drive shaft having at least one clutch.

10. A device according to claim 1, characterized in that the energy-transmission device (11) is located above a drive transmission device (6) of the mid-mounted motor drive unit (3) that drives the rear wheel.

11. A device according to claim 1, characterized in that the energy-transmission device (11) is at least partially arranged in a protective housing (17).

12. A device according to claim 1, characterized in that the energy-transmission device (11) and/or the recuperation element (12) and/or the first component (10), on the one hand, and a transmission device (9) of the mid-mounted motor drive unit (3) for driving the rear wheel, on the other hand, are arranged in essentially spatially separated regions on the bicycle (2), in particular on different sides of the bicycle (2).

13. A device according to claim 1, characterized in that the first component (10) is permanently connected to the rear wheel hub (4) or detachably connected to the rear wheel.

14. A device according to claim 13, characterized in that the first component engages into the spokes of the rear wheel for rotation.

15. A device according to claim 14, characterized in that the first component comprises at least one pin, in particular a plurality of pins for engaging with the spokes.

16. A method for operating a device according to claim 1, characterized in that energy recovery by means of the device is carried out depending on the operation of the bicycle (2).

17. A method according to claim 16, characterized in that sensor data, used for detecting the driving operation of the bicycle (2), is evaluated by a control device (15) and that energy is recovered based on the detected driving operation.

18. A method according to claim 16, characterized in that the energy recovery is carried out continuously and/or in steps, depending on the operation of the bicycle (2).

19. A method according to claim 16, characterized in that the energy recovery can be activated manually.

20. A bicycle with a device according to claim 1.
